(19) United States
(12) Patent Application Publication
(10) Pub. No.: US 2011/0088977 A1
(43) Pub. Date: Apr. 21, 2011

(54) STAIRLIFTS

(75) Inventor: Max Daniel Woodhams, Andover (GB)

(73) Assignee: Stannah Stairllifts Limited, Andover (GB)

(21) Appl. No.: 12/994,928

(22) PCT Filed: Jun. 5, 2009
(86) PCT No.: PCT/GB2009/001417

§ 371 Date: Nov. 29, 2010

(30) Foreign Application Priority Data
Jun. 13, 2008 (GB) 0810840.9

(51) Int. Cl. B66B 9/08

(52) U.S. Cl. 187/201

(57) ABSTRACT

The present invention enhances the safety of a stairlift by providing a movement sensor (46) to detect movement of the stairlift chair, such movement being deemed to indicate that a user is attempting to occupy or leave the chair. Upon detection of such movement, the stairlift hand control (38), and remote call controls (22, 24) are rendered inoperative. A chair occupancy sensor (40) may also be provided to restore power to the hand control (38) when the user is safely seated within the chair.

### FIELD OF THE INVENTION

This invention relates to stairlifts and, in particular, to a method of and/or apparatus for enhancing the safety of a stairlift installation. Whilst the invention has been devised, in particular, for incorporation into curved stairlifts, the invention is equally applicable to straight stairlifts.

### BACKGROUND TO THE INVENTION

There is currently a degree of risk involved when mounting or dismounting a stairlift. For example, most stairlift installations include remote call switches mounted at the top and bottom of the stairlift rail. These allow an intending user, remote from the stairlift carriage, to send a call signal to the stairlift in the event that the stairlift carriage is parked at the opposite end of the staircase. In such an instance, the intending user operating the call switch at a remote location may not be aware of a second user attempting to mount, or dismount from, the stairlift chair. In the case of a curved stairlift, for example, a person standing at one end of the staircase may not be able to see the opposite end of the staircase.

Current stairlift designs typically incorporate a carriage holding switch mounted on or adjacent to an armrest of the chair. When in the ‘off’ position this switch ensures that the stairlift cannot be operated and, when a user is mounting, or dismounting from the stairlift, the stairlift will not move if a call is made to the stairlift from one of the remote call switches.

Carriage holding switches on existing stairlift installations are a constant source of inconvenience and/or confusion. Users are instructed to move the switch to the ‘off’ position, at the end of each journey, so that the carriage cannot be moved whilst the user dismounts. The user is further instructed to then move the switch to the ‘on’ position, after dismounting, so that the empty chair may be moved under the control of the remote call switches. The switch must then be moved to the ‘off’ position again, for mounting. Given that typical users of stairlifts are elderly, to some extent physically incapacitated, and often easily confused, the need to constantly re-position the carriage holding switch often results in the correct procedure not being adopted. In some instances the carriage holding switch will not be turned off when mounting or dismounting the chair. This exposes a user to risk. In other instances, the switch may be left ‘off’ when the chair is empty, thus causing inconvenience to a second user attempting to call the carriage using one of the remote call switches.

Leaving aside the problems associated with accommodating second users, if the carriage holding switch is left ‘on’ while a user is mounting or dismounting the stairlift, and the user inadvertently displaces the carriage hand control, the carriage may move. Such movement could, in turn, lead to the user loosing their footing and even being injured.

A further problem with the existing carriage holding switches is that we have observed a tendency amongst some such users to assume that the stairlift is either not working correctly, or broken down, if the carriage holding switch has been inadvertently left in the ‘off’ position. This leads to unnecessary service call-outs.

In our published International Patent Application No. WO2005/012153 we describe a safety system which incorporates a proximity sensor to render inoperative the hand controls and landing call controls when a user approaches the stairlift chair. This system is particularly effective in multi-user environments but is relatively expensive to implement.

It is an object of this invention to provide a method of and/or means for controlling the operation of a stairlift which will go at least someway in addressing the aforementioned problems; or which will at least provide a novel and useful alternative.

### SUMMARY OF THE INVENTION

Accordingly, in a first aspect, the invention provides a method of enhancing the safety of a stairlift assembly having:

a rail extending between an upper end and a lower end of a staircase;
a carriage moveable along said rail;
a chair mounted on said carriage;
a user control operable by a user seated in said chair to displace said carriage along said rail; and
one or more remote controls, remote from said carriage, operable to displace said carriage along said rail independently from said user control,
said method including, when said carriage is at rest, sensing movement of said chair and, in the event movement is sensed, rendering inoperative said user control and said one or more remote controls.

Preferably said method includes rendering said user control and/or said one or more remote controls inoperative for a predetermined time period following movement of said chair being sensed.

Preferably said method further includes sensing when a user is fully occupying said chair.

In a second aspect the invention comprises a stairlift having:

a rail extending between an upper and lower end of a staircase;
a carriage moveable along said rail;
a chair mounted on said carriage;
a user control operable by a user seated in said chair to displace said carriage along said rail; and
one or more remote controls, remote from said carriage, operable to displace said carriage along said rail independently from said user control,
said stairlift being characterised in that it includes a movement sensor operable to sense movement of said chair; and a safety control operable in response to said movement sensor to render inoperative said user control and said one or more remote controls in the event movement of said chair is detected while said carriage is at rest.

Preferably said movement sensor is mounted on said chair or on said carriage.

Preferably said movement sensor comprises a vibration sensor.

Preferably said safety control is configured to render inoperative said user control and/or said one or more remote controls for a predetermined time period.

Preferably said installation further includes an occupancy sensor operable to detect the presence of a user fully seated in said chair.

Preferably said occupancy sensor comprises a load sensor incorporated in said chair.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future. The scope of the invention should be limited by the appended claims alone.

### BRIEF DESCRIPTION OF THE DRAWINGS

One preferred form of the invention will now be described with reference to the accompanying drawings in which:

FIG. 1: shows a plan view of a typical curved stairlift installation;

FIG. 2: shows an isometric view of a stairlift carriage and chair including various components which contribute to the present invention; and

FIG. 3: shows a diagrammatic view of a the user mounting, or dismounting from, the stairlift chair.

### DETAILED DESCRIPTION OF WORKING EMBODIMENT

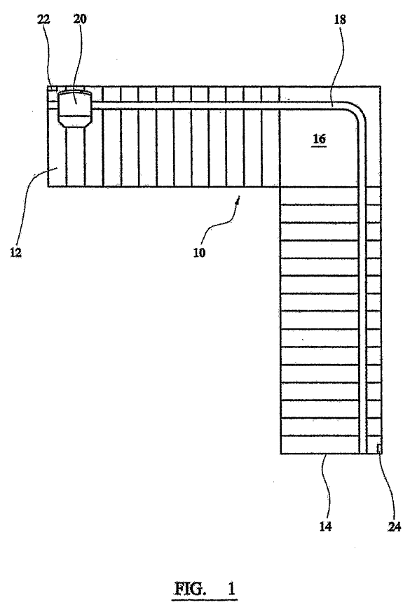

Referring firstly to FIG. 1, the invention provides a method of and/or means for, enhancing safety of a stairlift installation mounted in staircase 10. In the form shown the staircase 10 has an upper end 12, a lower end 14 and an intermediate landing 16. In accordance with conventional practice, a stairlift rail 18 is mounted to one side of the staircase and extends between the upper end 12 and lower end 14. A stairlift carriage and chair assembly 20 is mounted on the rail 18 for movement along the rail between the ends 12 and 14.

Also in accordance with conventional practice, remote landing controls or call switches 22 and 24 are provided on the staircase walls at or adjacent to the upper end 12 and lower end 14 respectively of the staircase. These remote switches, which could also be portable hand-held units, operate independently of the chair-mounted user control and allow a call signal to be sent to the stairlift in the event the carriage/chair 20 is parked at a location remote from the switch being activated. Thus, as illustrated in FIG. 1, operation of the remote control 24 would be used to call the carriage and chair to the lower end 14 of the staircase.

It will be appreciated that a person or intending user, located at the lower end 14 of the staircase illustrated in FIG. 1, would be unable to see the carriage and chair 20. Thus, if the carriage holding switch on the chair 20 were in the ‘on’ position, and a user was attempting to mount, or dismount from, the chair 20, any motion of the carriage induced by operation of remote switch 24 would be undesirable at least, and could lead to an injury being incurred.

In accordance with one aspect of the invention a chair movement sensor is provided to sense movement of the chair when the carriage is at rest. Whilst the carriage is at rest, movement of the chair is deemed to be an indication that a user is attempting to mount or leave the chair. In the event movement in these circumstances is detected, the remote controls 22 and 24, as well as the user hand control, are rendered inoperative.

The movement sensor is preferably mounted directly on the carriage or chair 20. The sensor may be positioned on that part of the chair which will displaced the most for a given displacing force. However, we have established that sensors are available which have sufficient sensitivity that they indicate displacement or vibration of the chair even when mounted on the main electronic circuit board positioned in the carriage. It follows that the precise form and placement of the movement sensor is not critical to the invention; a number of forms of displacement sensor, vibration sensor and/or g-sensor will suffice. In testing we have established that a vibration sensor manufactured and sold by Active Switch & Sensor Limited, under the model number VS 102, provides a level of movement detection suitable for use in the invention.

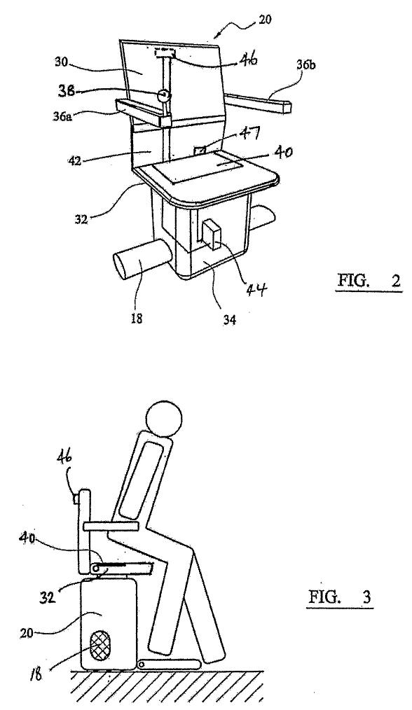

Referring now to FIG. 2, the stairlift carriage/chair assembly 20 is depicted mounted on rail 18. As can be seen the assembly includes a chair back 30 and a chair base 32 mounted on carriage chassis 34. The chair also includes arm rests 36a and 36b. Mounted at the outer end of armrest 36a is a conventional user control 38 by means of which a user seated in the chair may control the movement of the carriage/chair 20 along the rail 18.

Mounted on the rear part of the chair base 32 is an occupancy sensor, preferably in the form of load-sensitive pad 40, to provide an indication of whether or not a user is fully and safely occupying the chair. It is preferred to position the pad at the rear of the seat base 32 so that pressure is not applied to the pad (indicating that the chair is occupied) whilst the user is still in the act of occupying the chair. A signal from the sensor 40 is provided to the main stairlift control unit 44 mounted in the carriage.

Also mounted on or adjacent to the chair base 32 are a pair of further sensors 46 and 47 both of which are also connected to the stairlift control unit 44. The sensor 46 comprises the chair movement sensor described above and, for illustrative purposes, is shown mounted on the upper rear edge of the chair back 30. The sensor 47 serves to detect when the chair base 32 is folded up in the manner well-known in the stairlift art.

The sensors 40, 46 and 47, and control unit 44, are programmed to operate as follows:

As described above, the movement sensor 46 serves to detect if a user has made contact with the carriage chair assembly with the (assumed) intention of mounting, or dismounting from, the chair as is illustrated in FIG. 3. In either event, a signal is generated and provided by the movement sensor 46 to the main operating control unit 44 of the stairlift; and the remote controls 22 and 24, and the user hand control 38, are isolated. As a consequence, if a user inadvertently displaces the hand control 38 whilst moving into or out of the chair, the carriage will not be displaced. Similarly, the carriage/chair assembly 20 will not be displaced in the event a call is made, using one of remote switches 22 and 24, by a second or intending user to whom, for example, the carriage/chair 20 is not visible.

In a similar manner the sensor 40 detects when the user is, or is not, seated in the chair, and renders the user control 38 inoperative when there is no user seated in the chair. This prevents movement of the carriage/chair 20 if the user inadvertently touches or leans on the control 38 when mounting, or dismounting from, the chair.

Once the occupancy sensor 40 determines that the user is fully and safely in position in the chair, a signal is sent to control unit 44 which then re-activates the user control 38 and allows the user to drive the carriage/chair 20 up and down the rail 18. The remote controls 22 and 24 are also re-activated so that, if desired, the carriage may be displaced by an attendant using one of these controls.

When the occupancy sensor 40 determines that the chair is unoccupied and after the movement sensor 46 has failed to detect any movement of the chair for a defined period (say 8 seconds), then the control unit will allow the carriage to be moved in response to a call made from one of the remote controls 22 and 24. Likewise, the sensors 40 and 46 may be overridden if the sensor 47 determines that the chair is folded, thus allowing the folded chair/carriage to be displaced up and down the rail both in response to the landing controls 22 and 24, and by use of the user hand control 38.

It will thus be appreciated that the present invention, at least as incorporated in the working embodiment described above, enhances stairlift safety whilst obviating the inconvenience arising from the use or misuse of conventional carriage holding switches currently provided on stairlift carriages.

1. A method of enhancing the safety of a stairlift assembly, the method comprising the steps of:
providing a stairlift assembly comprising:
a rail extending between an upper end and a lower end of a staircase;
a carriage moveable along said rail;
a chair mounted on said carriage;
a user control operable by a user seated in said chair to displace said carriage along said rail; and
one or more remote controls, remote from said carriage, operable to displace said carriage along said rail independently from said user control,
sensing movement of said chair when said carriage is at rest and, in the event movement is sensed, rendering inoperative said user control and said one or more remote controls.

2. A method as claimed in claim 1 including rendering said user control and/or said one or more remote controls inoperative for a predetermined time period following movement of said chair being sensed.

3. A method as claimed in claim 1 further including sensing when a user is occupying said chair.

4. A stairlift having:
a rail extending between an upper and lower end of a staircase;
a carriage moveable along said rail;
a chair mounted on said carriage;
a user control operable by a user seated within said chair to displace said carriage along said rail;
one or more remote controls, remote from said carriage, operable to displace said carriage along said rail independently from said user control;
a movement sensor operable to sense movement of said chair; and
a safety control operable in response to said movement sensor to render inoperative said user control and said one or more remote controls in the event movement of said chair is detected while said carriage is at rest.

5. A stairlift as claimed in claim 4 wherein said movement sensor is mounted on said chair or on said carriage.

6. A stairlift as claimed in claim 4 wherein said movement sensor comprises a vibration sensor.

7. A stairlift as claimed in claim 4 wherein said safety control is configured to render inoperative said user control and/or said remote controls for a predetermined time period.

8. A stairlift as claimed in claim 4 further including an occupancy sensor operable to detect the presence of a user fully seated in said chair.

9. A stairlift as claimed in claim 8 wherein said occupancy sensor comprises a load sensor incorporated in said chair.
